(19) United States
(12) Patent Application Publication
(10) Pub. No.: US 2018/0105111 A1
(43) Pub. Date: Apr. 19, 2018

(54) Rear-View Mirror Wiper System

(71) Applicant: Frank Hill, Jacksonville, FL (US)

(72) Inventor: Frank Hill, Jacksonville, FL (US)

(21) Appl. No.: 15/296,105

(22) Filed: Oct. 18, 2016

(51) Int. Cl. B60R 1/06; B60S 1/08

(52) U.S. Cl. CPC B60R 1/0602; B60S 1/0811

(57) ABSTRACT

A rear-view mirror wiper system for wiping moisture from a rear-view mirror includes a vehicle. The vehicle has a pair of rear-view mirrors. A pair of wiping units is provided. Each of the wiping units is coupled to an associated one of the rear-view mirrors. Thus, each of the wiping wipes moisture from the mirror of the associated rear-view mirrors thereby enhancing visibility.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to wiper devices and more particularly pertains to a new wiper device for wiping moisture from a rear-view mirror.

### (h) BRIEF SUMMARY OF THE INVENTION

An embodiment of the disclosure meets the needs presented above by generally comprising a vehicle. The vehicle has a pair of rear-view mirrors. A pair of wiping units is provided. Each of the wiping units is coupled to an associated one of the rear-view mirrors. Thus, each of the wiping wipes moisture from the mirror of the associated rear-view mirrors thereby enhancing visibility.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a rear-view mirror wiper system according to an embodiment of the disclosure.

FIG. 2 is a front view of an embodiment of the disclosure.

FIG. 3 is a top phantom view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### (j) DETAILED DESCRIPTION OF THE INVENTION

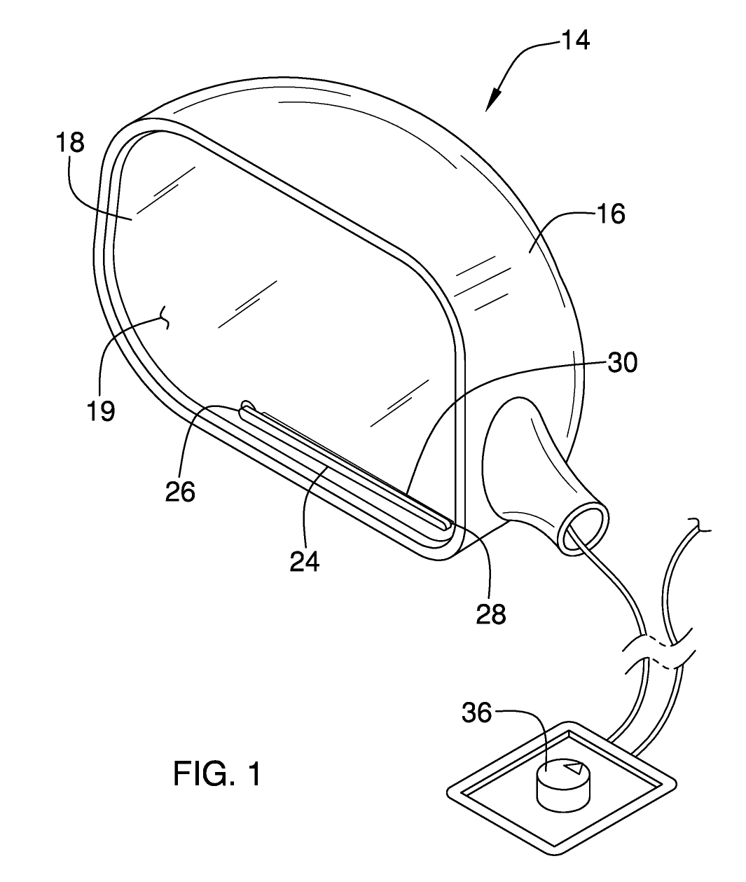

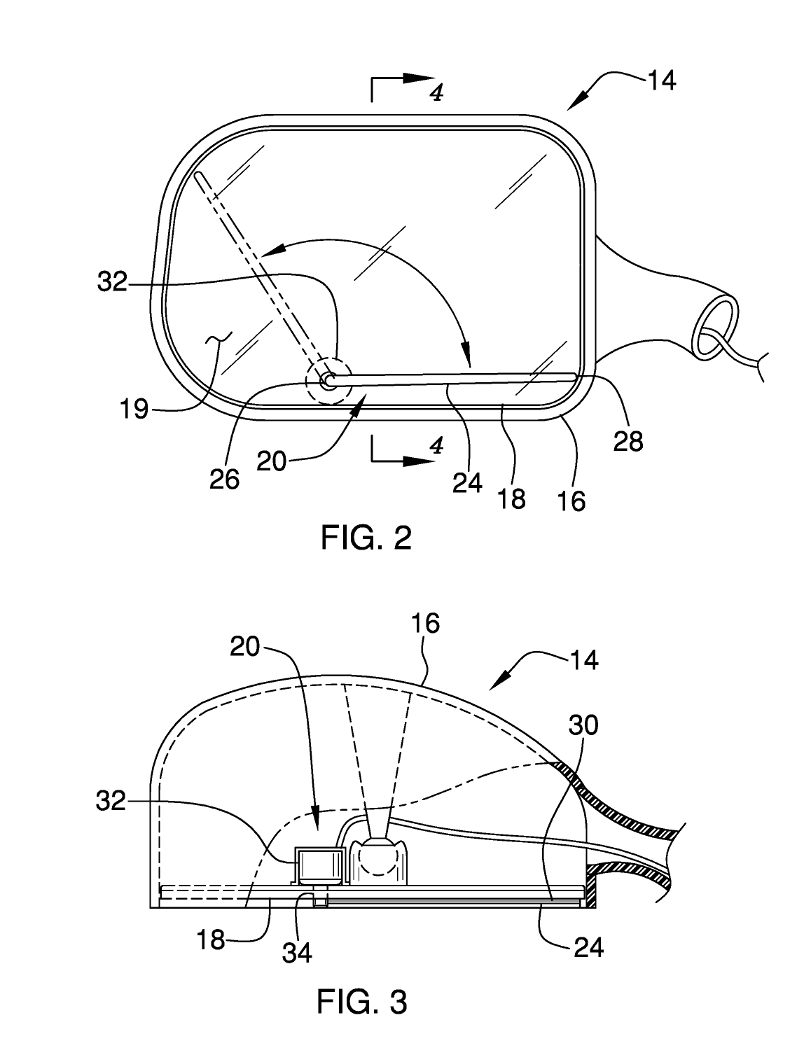

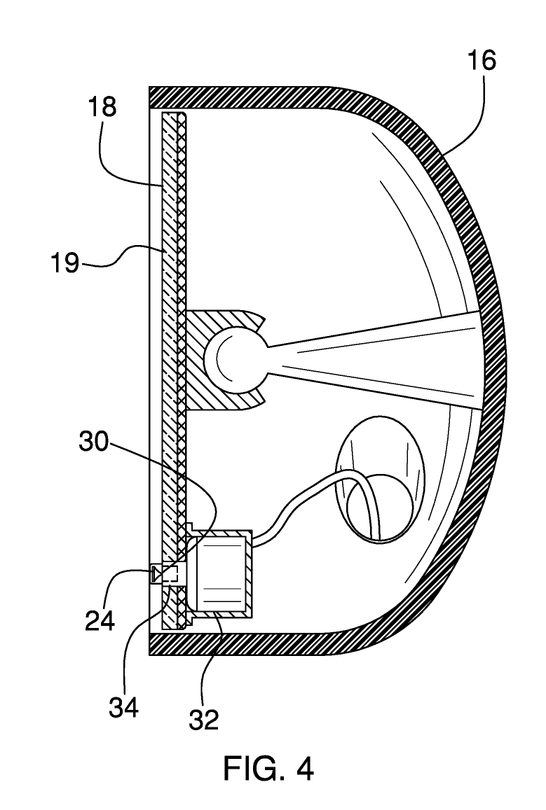

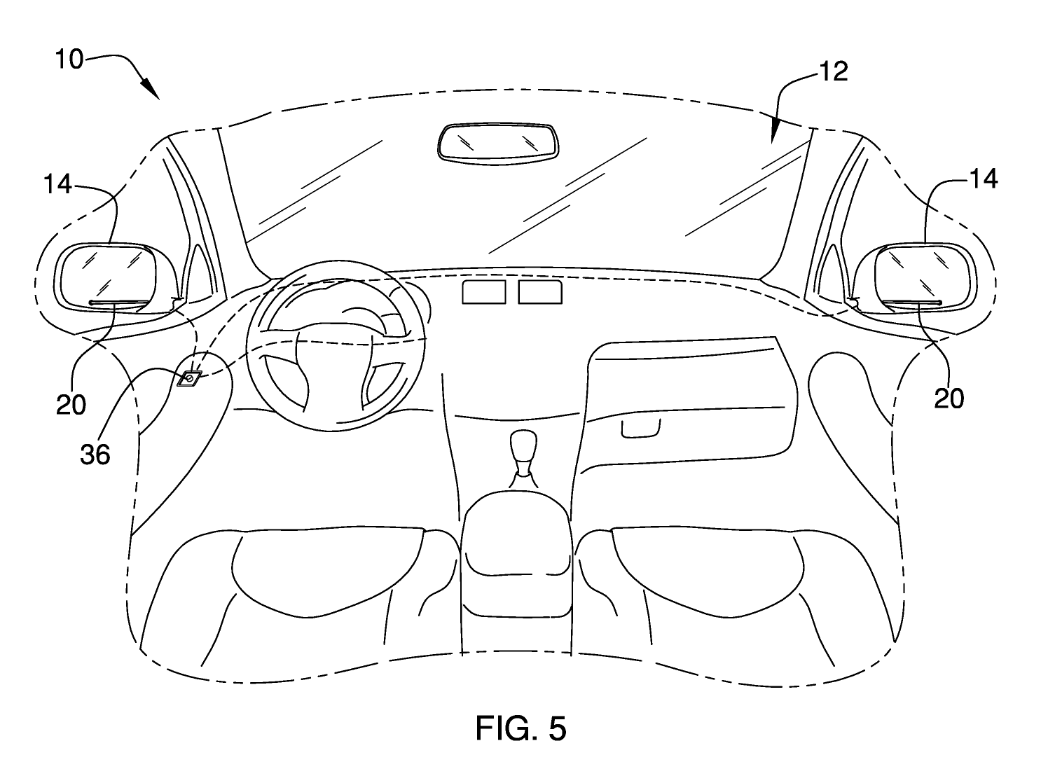

With reference now to the drawings, and in particular to FIGS. 1 through 5 thereof, a new wiper device embodying the principles and concepts of an embodiment of the disclosure and generally designated by the reference numeral 10 will be described.

As best illustrated in FIGS. 1 through 5, the rear-view mirror wiper system 10 generally comprises a vehicle 12 that has a pair of rear-view mirrors 14. Each of the rear-view mirrors 14 has a housing 16 and a mirror 18. The mirror 18 has a reflecting surface 19. The vehicle 12 may be a passenger vehicle 12 or the like.

A pair of wiping units 20 is provided. Each of the wiping units 20 is coupled to an associated one of the rear-view mirrors 14. Each of the wiping units 20 wipes moisture 22 from the mirror 18 of the associated rear-view mirrors 14. Thus, each of the wiping units 20 enhances visibility with respect to each of the rear-view mirrors 14. Each of the wiping units 20 may be a factory installed component of the vehicle 12. Alternatively, each of the wiping units 20 may be an after-market component with respect to the vehicle 12.

Each of the wiping units 20 comprises a wiper blade 24. The wiper blade 24 has a first end 26, a second end 28 and a wiping surface 30. The first end 26 is rotatably coupled to the mirror 18 of the associated rear-view mirror 18. The wiping surface 30 frictionally engages the reflecting surface 19 of the mirror 18. The wiping surface 30 may be comprised of a resiliently compressible material such as rubber or the like.

A motor 32 is provided. The motor 32 is positioned within the housing 16 of the associated rear-view mirror 18. The motor 32 alternatively rotates in a first direction and a second direction. The motor 32 may be an electric motor or the like. A shaft 34 is coupled between the motor 32 and the first end 26 of the wiper blade 24. The motor 32 urges the wiper blade 24 across the reflecting surface of the mirror 18.

A switch 36 is provided. The switch 36 is positioned within the vehicle 12 and the switch 36 may be manipulated. The switch 36 is electrically coupled to the vehicle 12. The switch 36 is electrically coupled to the motor 32 and the switch 36 turns the motor 32 on and off. The switch 36 may be a rheostat switch 36 or the like.

In use, the switch 36 is manipulated when moisture 22 collects on the mirror 18 corresponding to each of the rear-view mirrors 14. The motor 32 alternatively rotates in the first direction and the second direction. Thus, the wiper blade 24 travels back and forth across the mirror 18 to remove the moisture 22 from the mirror 18. The pair of wiping units 20 enhances visibility in each of the rear-view mirrors 14. Thus, each of the wiping units 20 enhances safety in wet driving conditions.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A rear-view mirror wiper system comprising:
a vehicle having a pair of rear-view mirrors, each of said rear view mirrors having a housing and a mirror, said housing defining an interior space, said mirror having a reflecting surface; and
a pair of wiping units, each of said wiping units being coupled to an associated one of said rear-view mirrors wherein each of said wiping units is configured to wipe moisture from said mirror of said associated rear-view mirrors thereby enhancing visibility, each of said wiping units having a motor being positioned within said interior space of said housing of said associated rear-view mirror, said motor alternatively rotating in a first direction and a second direction.

2. (canceled)

3. The system according to claim 2, wherein each of said wiping units comprises a wiper blade having a first end, a second end and a wiping surface, said first end being rotatably coupled to said mirror of said associated rear-view mirror proximate to a middle of a bottom edge of said mirror, said wiping surface frictionally engaging said reflecting surface of said mirror.

4. (canceled)

5. The system according to claim 1, further comprising:
a wiper blade having a first end; and
a shaft being coupled between said motor and said first end of said wiper blade such that said motor urges said wiper blade across said reflecting surface of said mirror.

6. The system according to claim 5, further comprising a switch being positioned within said vehicle wherein said switch is configured to be manipulated, said switch being electrically coupled to said vehicle, said switch being electrically coupled to said motor such that said switch turns said motor on and off.

7. A rear-view mirror wiper system comprising:
a vehicle having a pair of rear-view mirrors, each of said rear view mirrors having a housing and a mirror, said housing defining an interior space, said mirror having a reflecting surface; and
a pair of wiping units, each of said wiping units being coupled to an associated one of said rear-view mirrors wherein each of said wiping units is configured to wipe moisture from said mirror of said associated rear-view mirrors thereby enhancing visibility, each of said wiping units comprising:
a wiper blade having a first end, a second end and a wiping surface, said first end being rotatably coupled to said mirror of said associated rear-view mirror proximate to a middle of a bottom edge of said mirror, said wiping surface frictionally engaging said reflecting surface of said mirror,
a motor being positioned within said interior space of said housing of said associated rear-view mirror, said motor alternatively rotating in a first direction and a second direction,
a shaft being coupled between said motor and said first end of said wiper blade such that said motor urges said wiper blade across said reflecting surface of said mirror, and
a switch being positioned within said vehicle wherein said switch is configured to be manipulated, said switch being electrically coupled to said vehicle, said switch being electrically coupled to said motor such that said switch turns said motor on and off.
